(19) United States
(12) Patent Application Publication
(10) Pub. No.: US 2002/0152138 A1
(43) Pub. Date: Oct. 17, 2002

(54) Information providing method, information providing system, and apparatus for constructing the system

(76) Inventors: Shojo Ishioka, Fukayasu-gun (JP); Yuji Odan, Tosu-shi (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/030,098

(22) PCT Filed: May 17, 2001
(86) PCT No.: PCT/JP01/04099

(30) Foreign Application Priority Data
May 17, 2000 (JP) 2000-145297

(51) Int. Cl. G06F 17/60

(52) U.S. Cl. 705/27; 705/26

(57) ABSTRACT

The present invention provides an information service method, an information service system and a system component thereof, allowing users to purchase products with high reliability or credibility on a network. A user 101 checks a home page provided by an information provider 102 to input orders for a product for purchase and an investigation of the product. The information provider 102 receives identification information of the user/product and information of the order for the investigation, and then stores them in a database 102e with a certain association therebetween. According to the received investigation order, an investigation-instructing mechanism 102e sends an investigation agent 105a to a real store 104 to investigate the requested product. The investigation agent 105a reports a result of the investigation to a result-judging mechanism 102e. Then, information about the investigation result is transmitted from the information provider 102 to the user 101 via the Internet 103. The information provider 102 awaits a decision of the user on purchase of the product.

### TECHNICAL FIELD

The present invention relates to an information service method, an information service system and a system component thereof.

### BACKGROUND ART

In recent years, various products or services have been popularly traded in the market via networks. In such transaction, a seller or dealer publishes an image and/or specification of a product on a network, and then a network user makes decision on purchase of the product based on the published information. In this manner, the network user can purchase various products while sitting in the comfort of his/her house.

However, since the user is forced to purchase a product without actually looking and/or checking the product in hand, there is often the case that the quality and/or specification of the obtained product is different from those of his/her expectation.

The present invention is directed to solve the problem of the above prior art. It is therefore an objective of the present invention to propose an information service method, an information service system and a system component thereof allowing users to purchase products with high reliability or credibility on a network.

### DISCLOSURE OF THE INVENTION

In order to achieve the above object, according to a first aspect of the present invention, there is provided an information service method for providing information via a network including a first information-processing apparatus and a second information-processing apparatus. The information service method comprises the steps of: inputting identification information of a product for purchase from a user of the network to the first information-processing apparatus; inputting an order for a surrogate investigation of the product from the user to the first information-processing apparatus; transmitting identification information of the user, identification information of the product and an instruction on the surrogate investigation from the first information-processing apparatus to the second information-processing apparatus; storing the user identification information and the product identification information in the second information-processing apparatus; calling the product identification information from the second information-processing apparatus to identify the product so as to conduct an investigation of the identified product by an appointed investigation agent; and providing information obtained from the investigation to the user identified on the basis of the user identification information.

This information service method may further include the step of publishing information for designating a store and information about products dealt by the store on the network including the first and second information-processing apparatuses. In this case, the user identifies a product for purchase among the published products.

In above step of inputting an order of a surrogate-investigation, the level of the investigation or a deadline for the answer of the investigation may be designated.

According to a second aspect of the present invention, there is provided an information service system for providing information via a network comprising a first information-processing apparatus and a second information-processing apparatus. The first information-processing apparatus includes means for acquiring identification information of a product for purchase and an order of a surrogate investigation of the product, from the user of the network, and means for transmitting identification information of the user, identification information of the product and an instruction of the surrogate investigation, to the second information-processing apparatus. Further, the second information-processing apparatus includes means for storing the user identification information and the product identification information with a certain association therebetween, and means for providing information about a result of an investigation by an appointed investigation agent to the user. This investigation is related to the product identified on the basis of the information stored in the storing means.

The acquiring means may be operable to acquire the identification information of a product for purchase and the order in parallel with publishing information for designating a store and information about products dealt by the store on the network to provide them to the user.

The acquiring means may also be operable to acquire designated information about the level of the investigation or a deadline for the answer of the investigation from the user.

In order to achieve the above object, according to a third aspect of the present invention, there also is provided a server apparatus to be connected to an information-processing terminal via a network. The information-processing terminal includes means for acquiring identification information of a product for purchase and an order for a surrogate investigation of the product, from the user of the network, and means for transmitting identification information of the user, identification information of the product and an instruction of the surrogate investigation, to the server system. In this case, the server system comprises means for storing the user identification information and the product identification information with a certain association therebetween, and means for providing information about a result of an investigation by an appointed investigation agent to the user. This investigation is related to the product identified on the basis of the information stored in the storing means.

According to a fourth aspect of the present invention, there is provided an information-processing terminal to be connected to a server apparatus via a network. The server apparatus includes means for storing identification information of a user of the network and identification information of a product for purchase with a certain association therebetween, and means for providing information about a result of an investigation by an appointed investigation agent to the user. This investigation is related to the product identified on the basis of the information stored in the storing means. In this case, the information-processing terminal comprises means for acquiring identification information of a product for purchase and an order for a surrogate investigation of the product, from the user of the network, and means for transmitting the identification information of the user, the identification information of the product and an instruction on the surrogate investigation, to the server apparatus.

Furthermore, in order to achieve the above object, according to a fifth aspect of the present invention, there is provided a storage media storing a program to be read in and executed on a computer to implement the aforementioned server apparatus or information-processing terminal.

According to a sixth aspect of the present invention, there is provided an information service method comprising the steps of: acquiring identification information of an applicant for purchase and of a product for purchase designated by the applicant; storing the acquired identification information; acquiring an order for a surrogate investigation of the product from the applicant; and providing information obtained from an investigation of said the product by an appointed investigation agent to the applicant on a basis of the stored identification information.

### BRIEF DESCRIPTION OF THE DRAWINGS

FIG. 1 is a schematic diagram showing a general construction of an information service system according to a first embodiment of the present invention;

FIG. 2 illustrates an exemplary display of a home page of the information service system according to the first embodiment of the present invention;

FIG. 3 illustrates an exemplary display of a home page of the information service system according to the first embodiment of the present invention;

FIG. 4 illustrates an exemplary display of a home page of the information service system according to the first embodiment of the present invention;

FIG. 5 illustrates an exemplary display of a home page of the information service system according to the first embodiment of the present invention; and

FIG. 6 is a schematic diagram showing a general construction of an information service system according to a second embodiment of the present invention.

### BEST MODE FOR CARRYING OUT THE INVENTION

Referring to drawings, an exemplary preferred embodiment of the present invention will now be described in detail. The present invention is not limited to any arrangement, numerical value and the like of components described in this embodiment, excepting they are defined by a specific description.

<The First Embodiment>

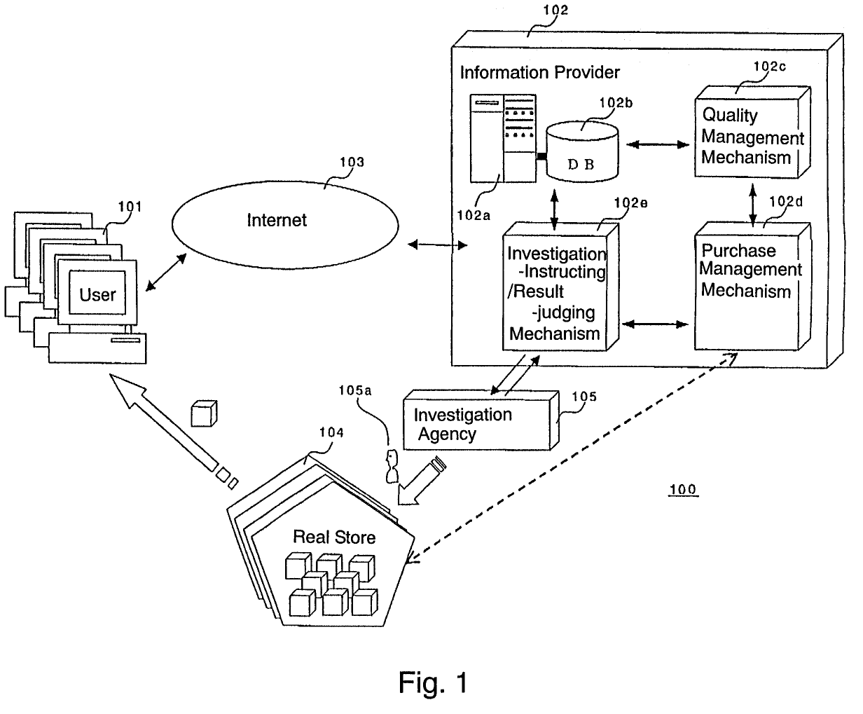

An information service system according to a first embodiment of the present invention will be described using FIGS. 1 through 5.

FIG. 1 is a schematic diagram showing a general construction of the information service system 100.

In FIG. 1, a user 101 and an information provider 102 are concurrently connected to the Internet 103, and are associated with each other to allow the user to freely access a home page created and published by the information provider. The information provider 102 has a sales intermediary contract with a real store 104 displaying and selling products. The information provider 102 creates a home page including information about features, prices and the like of the products sold by the real store 104, and publishes it on the Internet.

An investigation agency 105 has a tie-up agreement with the information provider 102. When receiving an investigation request from the information provider 102, an investigation agent 105a actually visits the designated real store 104, and investigates the designated product, followed by providing a report of the product to the information provider 102.

The information provider 102 comprises a server computer 102a for communicating over the Internet, a database (DB) 102b as a part of the server computer 102a, a quality management mechanism 102c for handling or processing complaints or the like from the user 101 against products, a purchase management mechanism 102d for managing charges or the like to the user 101, and an investigation-instructing/result-judging mechanism 102e for instructing an investigation to the investigation agency 105 and judging an investigation result from the investigation agency 105.

The flow of related information and a product in this information service system 100 will be briefly described as follows.

The user 101 checks the home page provided by the information provider 102 on his/her information terminal such as a computer to input a product for purchase and an order for an investigation of the selected product through the computer. The information provider 102 receives identification information of the user (name, address, telephone number or the like), identification information of a product (store name, maker, color, model or the like), and information about the investigation order. The received information is stored in the database 102e with a certain association therebetween.

Then, the investigation-instructing mechanism 102e of the information provider 102 requests the investigation to the investigation agency 105 according to the received investigation order. The investigation agency 105 received the request appoints an investigation agent 105a. The appointed investigation agent actually visits the real store 104, and conducts the investigation of the requested product. More specifically, the quality, the condition and the like of the product are investigated. The investigation agent 105a then reports a result of the investigation to the result-judging mechanism 102e. Then, information about the result of the investigation is transmitted from the information provider 102 to the user 101 via the Internet 103. The information provider 102 awaits a decision of the user 101 on purchase of the product.

When the user 101 decides to purchase the product based on the investigation result, the user 101 may access the home page of the information provider 102 and input a purchase order. Then, the address of the user 101, the product name, the number of the product and the like are informed from the information provider 102 to the real store 104, and the desired product is delivered from the real store 104 to the user 101.

The information provider 102 may design the home page such that when the user 101 accesses to a home page of the information provider 102, a prompt requests the user for inputting his/her identification information, such as ID name or the like, and the product for purchase, a purchase button and a purchase-cancel-button are displayed automatically on the computer of the user 101 according to the user identification information. In this case, the user 101 can input information about the decision on purchase or purchase-cancel of the product having the investigation result just after the user accesses the home page.

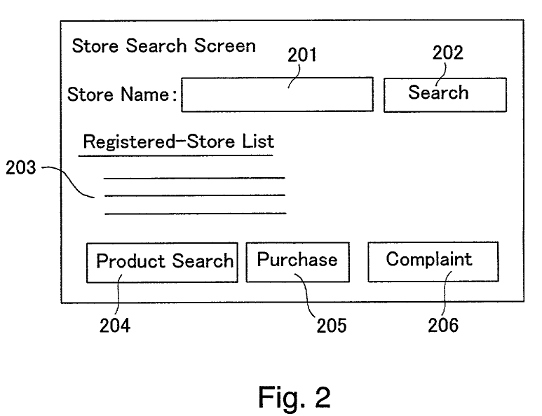

One example using this information service system will be described with reference to FIG. 2.

FIGS. 2 through 5 illustrate exemplary displays of a home page of an information provider to be accessed by users of this system.

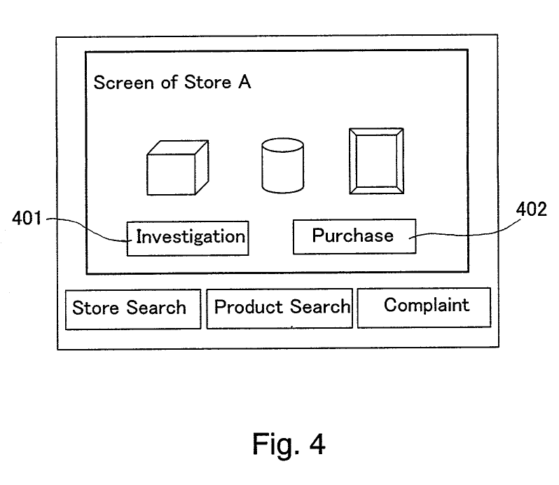

A screen as shown in FIG. 2 is first displayed as a screen page for searching stores. When a user desires to search stores, the user can input a specific store name into a dialog box 201 and click a search button 202. If the input store name is matched with one of stores registered in the database of the information provider, the user can go to a screen page of the store as shown in FIG. 4. This figure shows the state when a store A has been searched.

If the searched store and/or product have already been registered in previous accesses of the user, a registered store list 203 unique to the user will be displayed. The user may designate a store from the list. Moreover, if this screen page is adapted to display products associated with the stores in this registered store list, the user can select the displayed products and click a purchase button 205 to transmit information about an order for purchase to the information provider. Thus, the user can purchase the selected product without going to the screen page of the store. This allows operation time to be effectively shortened, for example, when the user purchases the product having the completed investigation result. For displaying the user unique list, it is required to identify the user. Thus, a screen page for prompting the input of the user ID is prepared before going to the screen page of FIG. 2.

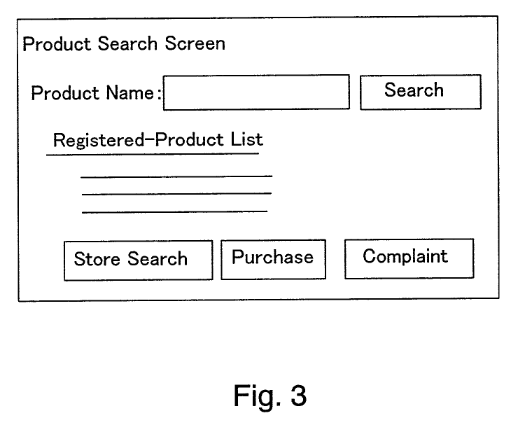

When a desired store name is not known, the user can click a product search button 204 to go to the product-search screen page as shown in FIG. 3. Then, the user can input a desired product name to search stores. Thus, even if the store name is unknown, the user can go to the home page of the store dealing the product as shown in FIG. 4. In the screen page of FIG. 3, the user-unique product list is also displayed, and the user can directly transmit a purchase order for a product from this screen page.

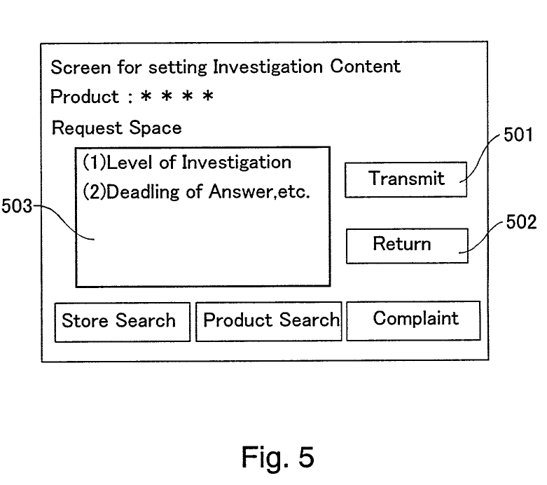

The screen page of the store of FIG. 4 displays products provided by the store. When the user selects a desired product and clicks an investigation button 401, the user can go to a screen page of FIG. 5 and designate desired investigation content in detail on an input space 503. When the user clicks a transmit button 501 after inputting the investigation content, the user information, store/product information and investigation order information are transmitted to the information provider. If a return button 502 is clicked, the user can return to the screen page of FIG. 4.

When requesting no investigation, the user can select a product on the screen page of the store in FIG. 4 and click a purchase button 402 to transmit the purchase order of the product to the information provider.

Actually, after clicking the purchase button, the user goes to a screen page (not show) for prompting the input of detailed information about the user (address, telephone number, payment method or the like). When the completion of all information input is confirmed, the purchase order information is transmitted to the information provider.

In each of the screen pages of FIGS. 2 through FIG. 5, a complaint button 206 is provided. The user can click the complaint button 206 to go to a complaint-transmit screen page (not shown) to transmit a complaint against the product and the investigation to the information provider.

According to this embodiment, the user can order to conduct an investigation of an product for purchase by an agent before purchasing the product. This allows the user to purchase the product with high reliability or credibility.

While each home page of stores is created and published by the information provider in this embodiment, another scheme may be contemplated, i.e. each store itself creates a home page and links it to the home page of the information provider.

<The Second Embodiment>

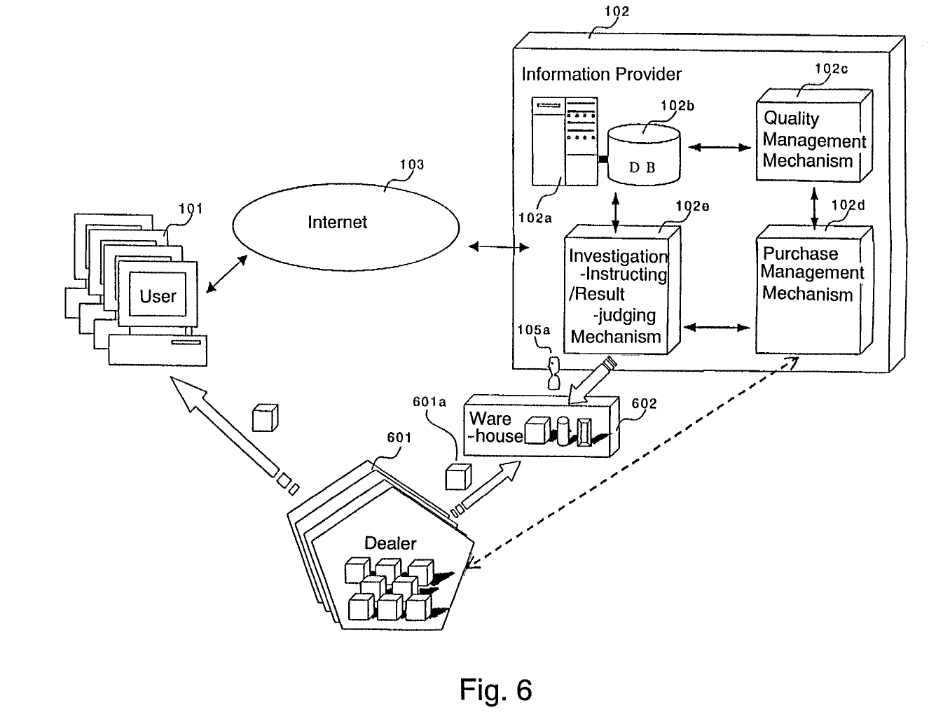

Another information service system as a second embodiment of the present invention will be described with reference to FIG. 6.

In the first embodiment, an investigation agent actually visits a real store and investigates a product. In this embodiment, various product samples are provided from suppliers such as manufacturers having no real store and are stored in a warehouse to allow the investigation agent to investigate them. Since other construction and function of the second embodiment are similar to those of the first embodiment, the same elements are defined by the same reference numbers and their description will be omitted.

As illustrated, a dealer 601 sends a sample of a product 601 a to the information provider 102, and the information provider 102 stores the sample 601 a in a warehouse 602. Since the information provider 102 is not required to send the investigation agent 105a to a plurality of stores 104 as in FIG. 1, the number of the investigation agent 105a and travel expenses for the investigation can be reduced. In addition, reduced number of the investigation agent 105a provides lowered variation in investigation accuracy.

### INDUSTRIAL APPLICABILITY

The present invention can provide an information service method, an information service system and a system component thereof, allowing users to purchase products with high reliability or credibility on a network.

What is claimed is:

1. An information service method for providing information via a network including a first information-processing apparatus and a second information-processing apparatus, said information service method comprising steps of:
inputting identification information of a product for purchase from a user of said network to said first information-processing apparatus;
inputting an order for a surrogate investigation of said product from said user to said first information-processing apparatus;
transmitting identification information of said user, identification information of said product and an instruction on said surrogate investigation from said first information-processing apparatus to said second information-processing apparatus;
storing said user identification information and said product identification information in said second information-processing apparatus;
calling said product identification information from said second information-processing apparatus to identify said product so as to conduct an investigation of said identified product by an appointed investigation agent; and
providing information obtained from said investigation to said user identified on the basis of said user identification information.

2. An information service method as defined in claim 1, which further includes a step of publishing information for designating a store and information about products dealt by said store on said network including said first and second information-processing apparatuses, wherein said user identifies a product for purchase among said published products.

3. An information service method as defined in claim 1 or 2, wherein said step of inputting an order for a surrogate investigation includes designating the level of said investigation or a deadline for the answer of said investigation.

4. An information service system for providing information via a network, said information service system comprising: a first information-processing apparatus and a second information-processing apparatus,
said first information-processing apparatus including,
means for acquiring identification information of a product for purchase and an order of a surrogate investigation of said product, from said user of said network, and
means for transmitting identification information of said user, identification information of said product and an instruction of said surrogate investigation, to said second information-processing apparatus; and
said second information-processing apparatus including,
means for storing said user identification information and said product identification information with a certain association therebetween, and
means for providing information about a result of an investigation by an appointed investigation agent to said user, said investigation being related to said product identified on the basis of said information stored in said storing means.

5. An information service system as defined in claim 4, wherein said acquiring means is operable to acquire the identification information of a product for purchase and the order in parallel with publishing information for designating a store and information about products dealt by said store on said network to provide them to said user

6. An information service system as defined in claim 4 or 5, wherein said acquiring means is operable to acquire designated information about the level of said investigation or a deadline for the answer of said investigation from said user.

7. A server apparatus to be connected to an information-processing terminal via a network, said information-processing terminal including:
means for acquiring identification information of a product for purchase and an order for a surrogate investigation of said product, from said user of said network; and
means for transmitting identification information of said user, identification information of said product and an instruction of said surrogate investigation, to said server system, and wherein
said server system comprises:
means for storing said user identification information and said product identification information with a certain association therebetween; and
means for providing information about a result of an investigation by an appointed investigation agent to said user, said investigation being related to said product identified on the basis of said information stored in said storing means.

8. A computer readable media storing a program to be read in and executed on a computer to implement the server apparatus as defined in claim 7.

9. An information-processing terminal to be connected to a server apparatus via a network, said server apparatus including:
means for storing identification information of a user of said network and identification information of a product for purchase with a certain association therebetween; and
means for providing information about a result of an investigation by an appointed investigation agent to said user, said investigation being related to said product identified on the basis of said information stored in said storing means, and wherein
said information-processing terminal comprises:
means for acquiring identification information of a product for purchase and an order for a surrogate investigation of said product, from said user of said network; and
means for transmitting said identification information of said user, said identification information of said product and an instruction on said surrogate investigation, to said server apparatus.

10. A computer readable media storing a program to be read in and executed on a computer to implement the information-processing terminal as defined in claim 9.

11. An information service method comprising the steps of:
acquiring identification information of an applicant for purchase and of a product for purchase designated by said applicant;
storing said acquired identification information;
acquiring an order for a surrogate investigation of said product from said applicant; and
providing information obtained from an investigation of said the product by an appointed investigation agent, to said applicant on a basis of the stored identification information.
